(19) United States
(12) Patent Application Publication
(10) Pub. No.: US 2018/0268992 A1
(43) Pub. Date: Sep. 20, 2018

(54) THREE-PHASE REACTOR HAVING INSULATING STRUCTURE

(71) Applicant: FANUC CORPORATION, Yamanashi (JP)

(72) Inventors: Kenichi Tsukada, Yamanashi (JP); Masatomo Shirouzu, Yamanashi (JP)

(73) Assignee: FANUC CORPORATION, Yamanashi (JP)

(21) Appl. No.: 15/920,689

(22) Filed: Mar. 14, 2018

(30) Foreign Application Priority Data
Mar. 17, 2017 (JP) 2017-053321

(51) Int. Cl. H01F 27/32; H01F 27/24; H01F 27/02; H01F 27/28

(52) U.S. Cl. CPC H01F 27/325; H01F 27/2823; H01F 27/02; H01F 27/24

(57) ABSTRACT

A three-phase reactor according to an embodiment of this disclosure includes a coil having a winding portion; an iron core partly disposed inside the winding portion; and a covering portion containing the coil, and having an opening.

This application is a new U.S. patent application that claims benefit of JP 2017-053321 filed on Mar. 17, 2017, the content of 2017-053321 is incorporated herein by reference.

### BACKGROUND OF THE INVENTION

### 1. Field of the Invention

The present invention relates to a three-phase reactor, and more specifically relates to a three-phase reactor having an insulating structure.

### 2. Description of Related Art

Reactors are used in order to reduce harmonic current occurring in inverters, etc., to improve input power factors, and to reduce inrush current to the inverters. Reactors include an iron core made of a magnetic material and a coil formed around the iron core.

Insulation must be ensured between the iron core and the coil. As an example, a reactor having insulating paper between an iron core and a coil is known (for example, Japanese Unexamined Patent Publication (Kokai) No. 2012-142350). In the reactor according to the conventional art, an iron core covered with the insulating paper is inserted into a cavity of the coil. Furthermore, in a three-phase reactor, since coils are disposed next to each other, insulation must also be ensured between the individual coils.

### SUMMARY OF THE INVENTION

However, reactors in conventional art require a process for ensuring insulation between the coil and the iron core, and a process for ensuring insulation between the individual coils.

A three-phase reactor according to an embodiment of this disclosure includes a coil having a winding portion;

an iron core partly disposed inside the winding portion; and a covering portion containing the coil, and having an opening.

### BRIEF DESCRIPTION OF THE DRAWINGS

The objects, features, and advantages of the present invention will become more apparent from the following description of embodiments along with accompanying drawings. In the accompanying drawings:

FIG. 1 is an exploded perspective view of part of a three-phase reactor according to a first embodiment;

FIG. 2 is a perspective view of the part of the three-phase reactor according to the first embodiment;

FIG. 3 is a perspective view of the part of the three-phase reactor according to the first embodiment;

FIG. 4 is a perspective view of part of a three-phase reactor according to a modification example of the first embodiment;

FIG. 5 is a plan view of a three-phase reactor according to a second embodiment;

FIG. 6 is a perspective view of part of the three-phase reactor according to the second embodiment;

FIG. 7 is an exploded perspective view of the part of the three-phase reactor according to the second embodiment;

FIG. 8A is a plan view of the part of the three-phase reactor according to the second embodiment;

FIG. 8B is a cross-sectional view of the part of the three-phase reactor according to the second embodiment;

FIG. 9 is a perspective view of part of a three-phase reactor according to a fourth embodiment; and

FIG. 10 is an exploded perspective view of part of a three-phase reactor according to a fifth embodiment.

### DETAILED DESCRIPTION OF THE INVENTION

A three-phase AC reactor according to the present invention will be described below with reference to the drawings. However, the technical scope of the present invention is not limited to these embodiments, but encompasses the invention described in claims and equivalents thereof.

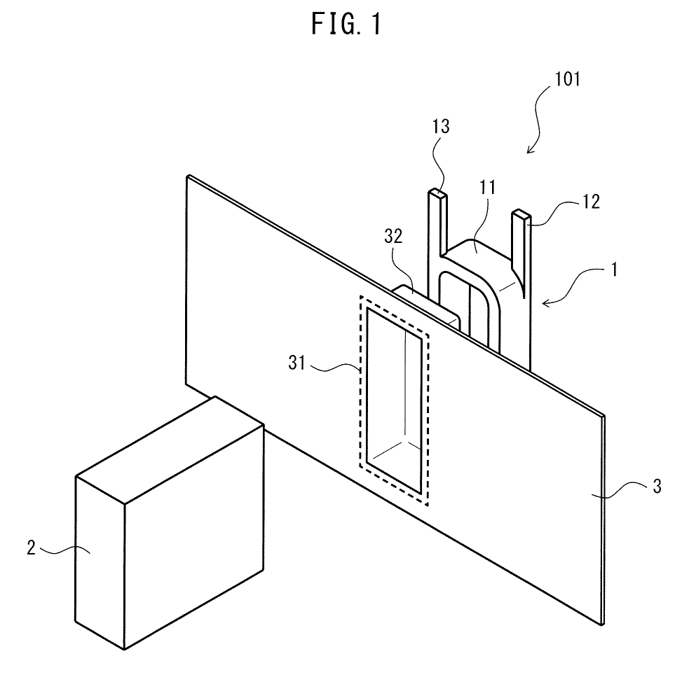

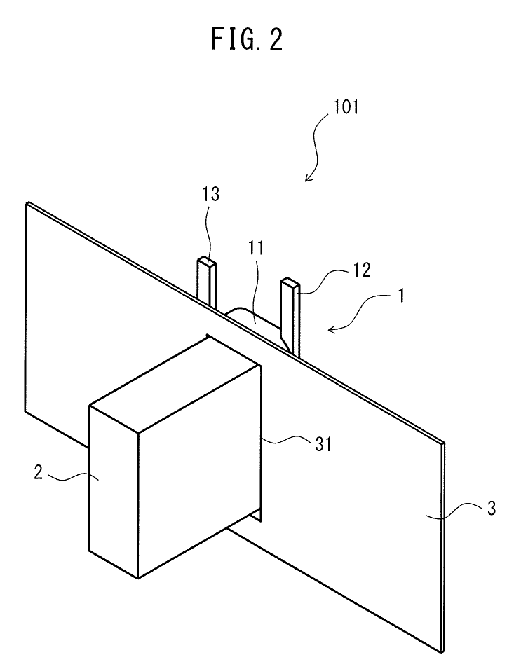

FIG. 1 is an exploded perspective view of part of a three-phase reactor according to a first embodiment. FIG. 2 is a perspective view of the part of the three-phase reactor according to the first embodiment. A three-phase reactor 101 according to the first embodiment includes coils 1, iron cores 2, and covering portions 3. FIG. 1 illustrates only one reactor constituting the three-phase reactor, but the three-phase reactor includes three reactors.

The coil 1 includes a winding portion 11 in which a conductor is wound helically. As the conductor, a rectangular wire, a round wire, etc., made of a conductive material containing copper, aluminum, magnesium, etc., can be used. Ends of the winding portion 11 are connected to an external device, as an input terminal 12 and an output terminal 13. An approximately rectangular space is formed inside the winding portion 11.

Part of the iron core 2 is disposed inside the winding portion 11 of the coil 1.

The covering portion 3 contains the coil 1, and has an opening 31. The covering portion 3 may have an insulating member 32. The insulating member 32 is disposed between an inner peripheral surface of the winding portion 11 and the iron core 2, and is integrated with the covering portion 3. The covering portion 3 may be formed of a sheet of an insulating material.

FIG. 1 illustrates a state in which the iron core 2, the covering portion 3, and the coil 1 are separated. FIG. 2 illustrates a state in which the iron core 2 is inserted into the winding portion 11 of the coil 1 through the opening 31 of the covering portion 3.

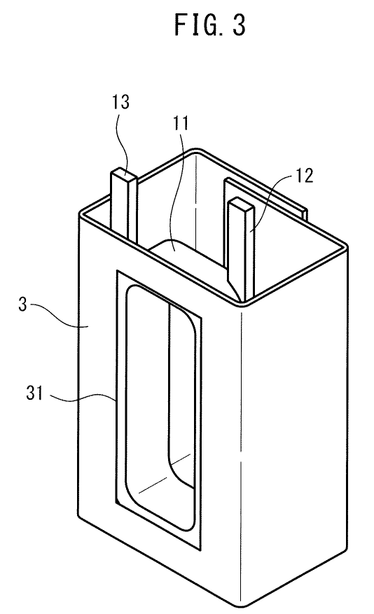

FIG. 3 is a perspective view of the part of the three-phase reactor according to the first embodiment. As shown in FIG. 3, the covering portion 3 is preferably bent so as to enclose the coil 1, in the state of fitting the opening 31 of the covering portion 3 on the space formed inside the winding portion 11 of the coil 1. FIG. 3 omits the iron core 2 and the insulating member 32.

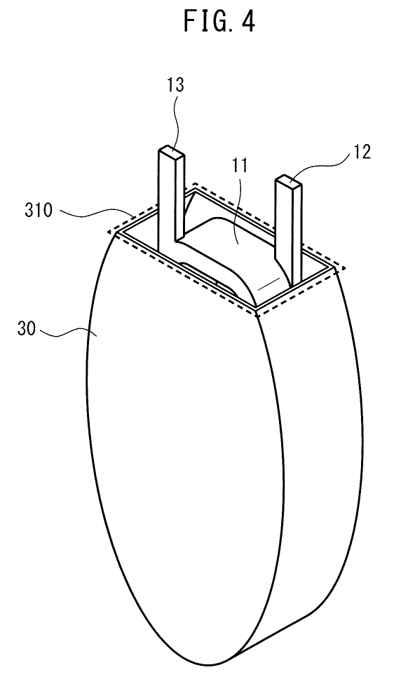

FIG. 4 is a perspective view of part of a three-phase reactor according to a modification example of the first embodiment. As shown in FIG. 4, a covering portion 30 may be formed of a pouched insulating material. The pouched covering portion 30 is provided with an upper opening 310 to insert a coil 1 therein. The pouched covering portion 30 further includes an opening to insert an iron core 2 into a winding portion 11 of the coil 1, though FIG. 4 omits the opening.

As described above, the three-phase reactor according to the first embodiment includes the covering portion that contains the coil, and has the opening. Since the entire coil is covered with the insulating material, it is possible to easily ensure insulation between the individual coils, and between the coil and the iron core.

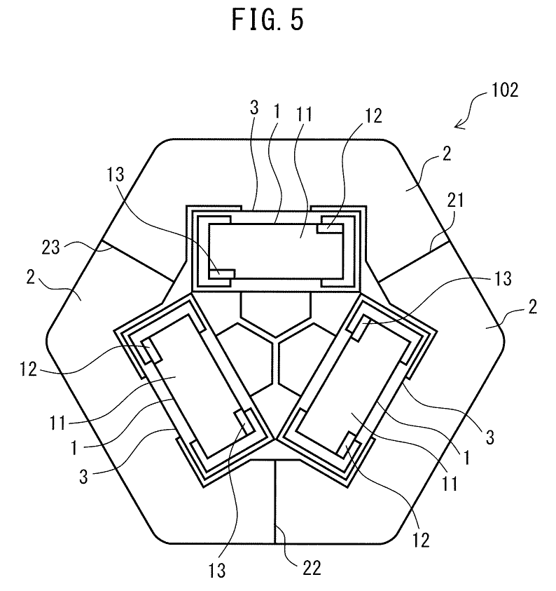

A three-phase reactor according to a second embodiment will be described. FIG. 5 is a plan view of the three-phase reactor according to the second embodiment. The difference between a three-phase reactor 102 according to the second embodiment and the three-phase reactor 101 according to the first embodiment is that the three-phase reactor 102 includes an outer peripheral iron core, and at least three core coils contacting, connected to, or magnetically connected to an inner surface of the outer peripheral iron core. Each of the core coils is constituted of an iron core and a coil wound around the iron core. The other structure of the three-phase reactor 102 according to the second embodiment is the same as that of the three-phase reactor 101 according to the first embodiment, so a detailed description thereof is omitted.

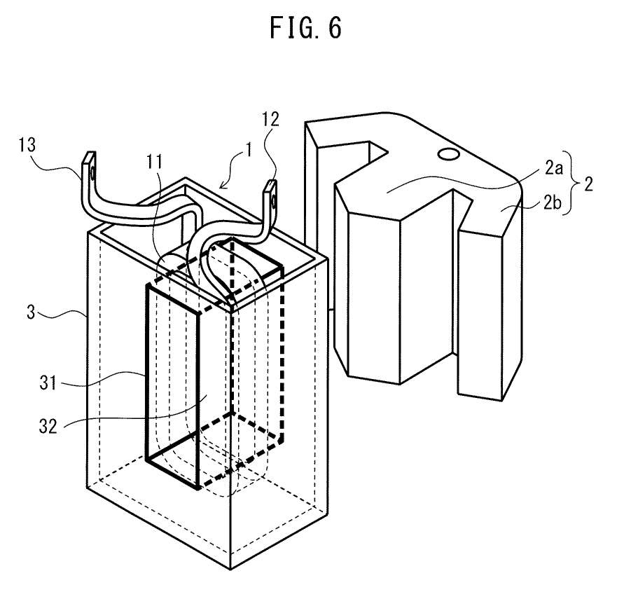

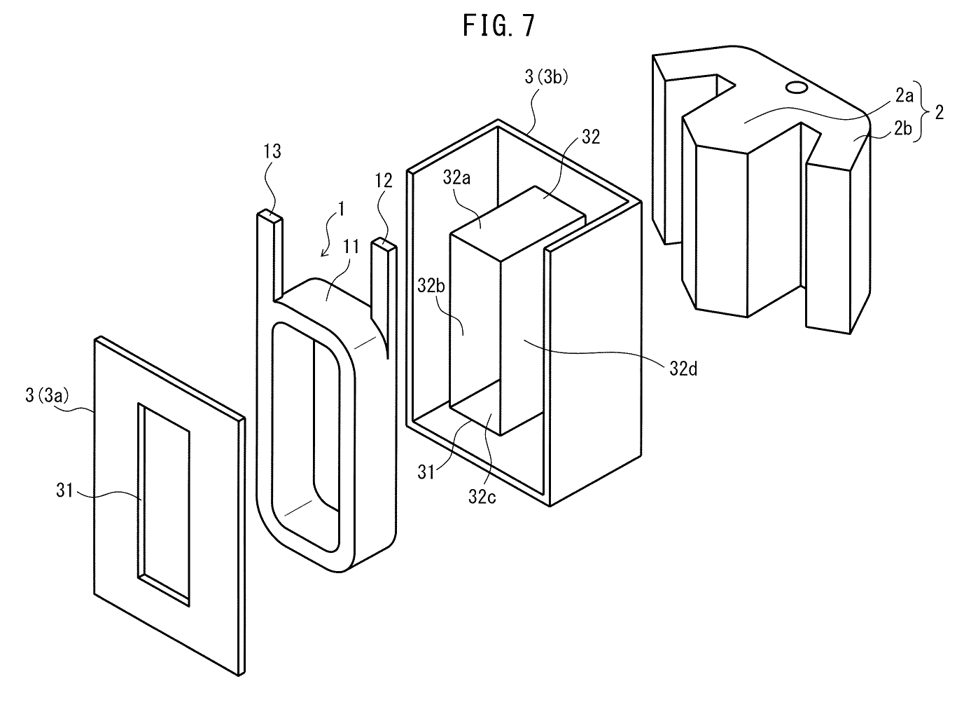

FIG. 6 is a perspective view of part of the three-phase reactor according to the second embodiment. FIG. 7 is an exploded perspective view of the part of the three-phase reactor according to the second embodiment.

FIG. 5 shows an example of an assembled three-phase reactor, in which three pairs of coils 1 and iron cores 2 are arranged in positions rotated by 120°. The three coils 1 correspond to R-phase, S-phase, and T-phase coils.

The iron cores 2 constitute one iron core unit as a whole, but are divided by three dividing surfaces (21, 22, and 23). Since attachment of the coil 1 and the covering portion 3 to the iron core 2 is performed for the divided iron core 2, the divided iron core 2 will be described below.

As shown in FIGS. 5 and 6, part of the iron core 2 disposed inside the winding portion 11 is referred to as an inner peripheral iron core 2a. On the other hand, part of the iron core 2 disposed in an outer periphery of the three-phase reactor is referred to as an outer peripheral iron core 2b. The iron core 2 may be made of a lamination of electrical steel sheets. Alternatively, the iron core 2 may be made of a pressed powder material.

The covering portion 3 contains the coil 1, and has an opening 31 to dispose part of the iron core 2 inside a winding portion 11. As shown in FIG. 6, the covering portion 3 preferably has the shape of a box having an opened top. Furthermore, as shown in FIG. 7, the covering portion 3 may be constituted of a lid 3a and a covering portion main body 3b. Dividing the covering portion 3 into the two components facilitates attachment of the coil 1 to the covering portion 3. For example, as shown in FIG. 7, the coil 1 may be attached to the covering portion main body 3b, and thereafter the lid 3a may be integrated into the covering portion main body 3b by bonding, crimping, etc. The covering portion 3 may be made of a resin material. As the resin material, a thermoplastic resin, a thermosetting resin, etc., can be used.

In the covering portion 3, the opening 31 is formed to dispose the inner peripheral iron core 2a in an inner periphery of the coil 1. By inserting the inner peripheral iron core 2a, i.e., part of the iron core 2, into the opening 31, the inner peripheral iron core 2a can be disposed inside the winding portion 11. The opening 31 preferably has a shape along the cross-sectional shape of the inner peripheral iron core 2a.

An insulating member 32 is disposed between an inner peripheral surface of the winding portion 11 and the inner peripheral iron core 2a, i.e., part of the iron core 2, and is integrated with the covering portion main body 3b, i.e., part of the covering portion 3. As shown in FIG. 7, the insulating member 32 is preferably constituted of four members (32a, 32b, 32c, and 32d ) that are integrated into one unit in accordance with the four inner peripheral surfaces of the coil 1. The four members (32a, 32b, 32c, and 32d ) constituting the insulating member 32 correspond to the sides of the rectangular opening 31 formed in the lid 3a of the covering portion 3. The insulating member may be made of a highly insulative resin material. As the resin material, a thermoplastic resin, a thermosetting resin, etc., can be used.

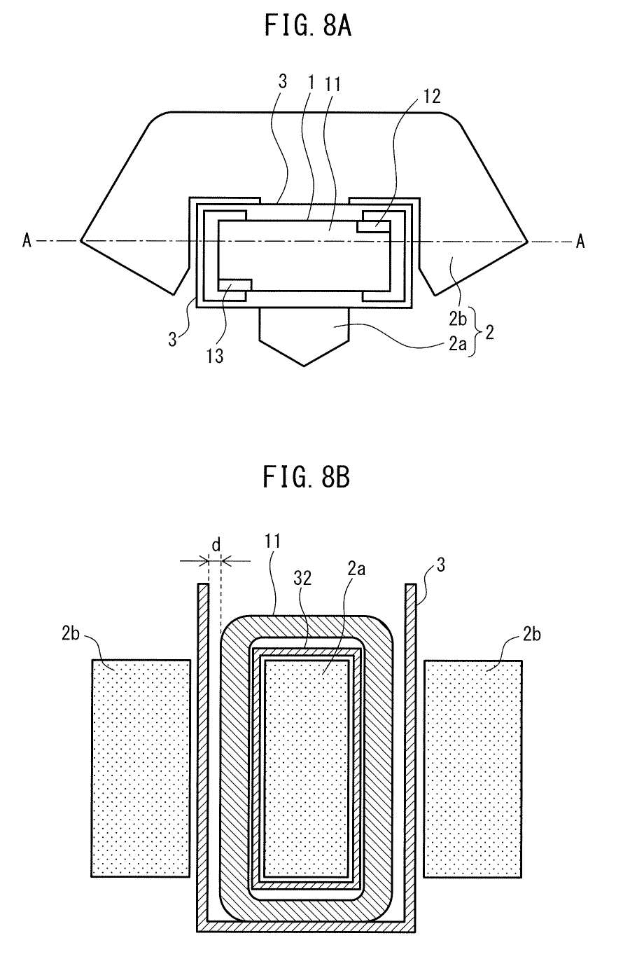

FIG. 8A is a plan view of the part of the three-phase reactor according to the second embodiment. FIG. 8B is a cross-sectional view of the part of the three-phase reactor according to the second embodiment, taken along line A-A of FIG. 8A. The insulating member 32 disposed between the inner peripheral surface of the winding portion 11 and the inner peripheral iron core 2a, i.e., part of the iron core 2, ensures insulation between the coil 1 and the iron core 2.

Furthermore, the insulating member 32 may be integrated with the lid 3a, which is part of the covering portion 3. Alternatively, as shown in FIG. 7, the insulating member 32 may be molded integrally with the covering portion main body 3b. As a method for molding the insulating member 32 integrally with the covering portion main body 3b, injection molding can be considered. Alternatively, after the insulating member 32 and the covering portion main body 3b are manufactured separately, the insulating member 32 and the covering portion main body 3b may be integrated by bonding, crimping, etc. This structure allows for the formation of the insulating member 32 and the covering portion 3 of different materials.

In the three-phase reactor according to the second embodiment, the covering portion having the insulating member can be easily manufactured by integrating the insulating member and the covering portion, and the assembly process is thereby simplified, as compared to the case of using insulating paper to ensure insulation. As a result, it is possible to eliminate the need to provide a component to secure the insulating paper, thus allowing a reduction in the number of components.

As shown in FIG. 8B, a gap of a predetermined distance d is preferably formed between an outer periphery of the coil 1 and an inner wall of the covering portion 3. By blowing outside air into the formed gap, the air flows inside the iron core in the axial direction (longitudinal direction), so that heat generated by the coil 1 is released to the outside. This structure has the effect of reducing heat generation, even if the coil 1 is covered with the covering portion 3.

As shown in FIG. 8B, the coil 1 is preferably disposed so as to contact a bottom surface of the covering portion 3. This stabilizes the positional relationship between the coil and the insulating member, thus preventing a deterioration in the insulating member.

A three-phase reactor according to a third embodiment of this disclosure will be described. The difference between the three-phase reactor according to the third embodiment and the three-phase reactor according to the second embodiment is that a covering portion 3 is filled with an impregnant or a resin. The other structure of the three-phase reactor according to the third embodiment is the same as that of the second embodiment, so a detailed description thereof is omitted.

The impregnant or the resin may be contained so as to immerse the entire winding portion 11 of the coil 1 in the impregnant or the resin, or to immerse only part of the winding portion 11 in the impregnant or the resin. When the winding portion 11 of the coil 1 vibrates significantly, the impregnant or the resin is preferably contained so as to immerse the entire winding portion 11 therein. On the other hand, when the vibration of the winding portion 11 of the coil 1 is relatively small, containing the impregnant or the resin so as to immerse only part of the winding portion 11 therein holds promise of preventing the vibration, and promise of having the effect of heat dissipation from part of the winding portion 11 that is not immersed in the impregnant or the resin.

Filling the covering portion 3 with the impregnant or the resin can secure the coil, and prevent vibration (magnetization noise). As the impregnant, for example, an epoxy impregnant can be used.

A three-phase reactor according to a fourth embodiment of this disclosure will be described. The difference between the three-phase reactor according to the fourth embodiment and the three-phase reactor according to the second embodiment is slits 33 are provided in at least part of a covering portion. The other structure of the three-phase reactor according to the fourth embodiment is the same as that of the three-phase reactor according to the second embodiment, so a detailed description thereof is omitted.

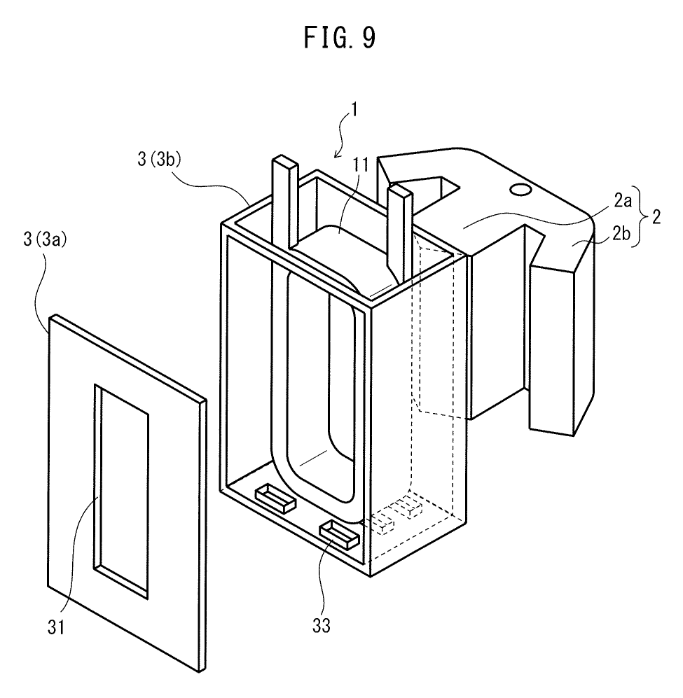

FIG. 9 is a perspective view of part of a three-phase reactor according to the fourth embodiment. As shown in FIG. 9, slits 33 are preferably provided in a bottom surface of a covering portion 3, which is constituted of a lid 3a and a covering portion main body 3b. This structure allows outside air to be taken in through the slits 33 and to be ejected from the opened top of the covering portion 3. As a result, heat generation from the coil 1 can be prevented.

In the example of FIG. 9, the slits 33 are provided only in the bottom surface of the covering portion main body 3b of the covering portion 3, but the present invention is not limited to this example. For example, slits may be provided in the side surfaces of the covering portion 3 or the lid 3a of the covering portion 3. Furthermore, slits may be provided in the surface of the covering portion main body 3b opposite the lid 3a.

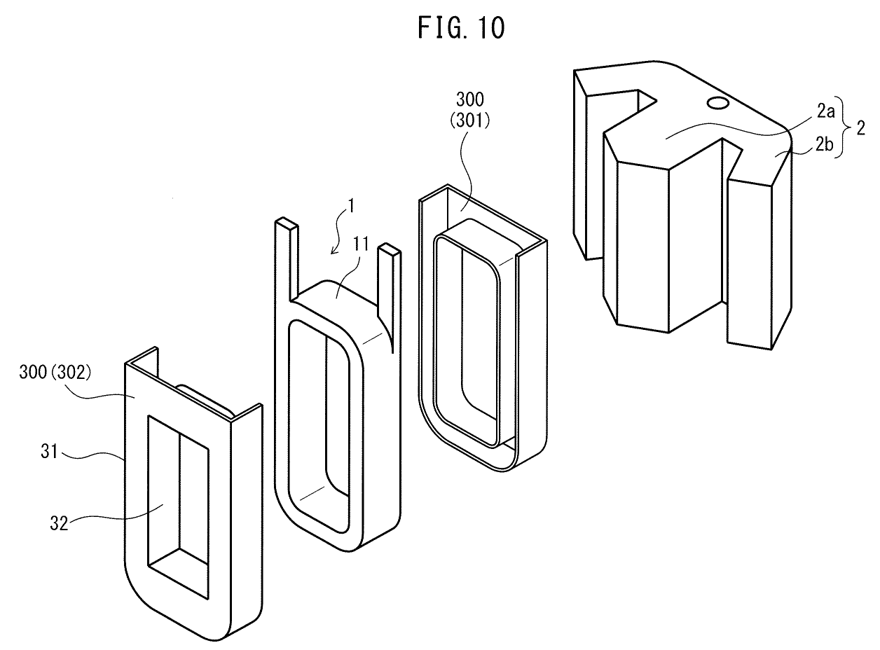

A three-phase reactor according to a fifth embodiment of this disclosure will be described. FIG. 10 is an exploded perspective view of part of the three-phase reactor according to the fifth embodiment of this disclosure. The difference between the three-phase reactor according to the fifth embodiment and the three-phase reactor according to the second embodiment is that the covering portion 300 has a covering portion main body 301 and a lid 302, and at least part of outer peripheries of the covering portion main body 301 and the lid 302 have shapes along an outer periphery of a coil. The other structure of the three-phase reactor according to the fifth embodiment is the same as that of the three-phase reactor according to the second embodiment, so a detailed description thereof is omitted.

As shown in FIG. 10, the covering portion constituting the three-phase reactor according to the fifth embodiment has the same structure as a coil bobbin, and more specifically, has the same structure as a coil bobbin having an opening 31 therein. Therefore, an insulating member 32 provided in the lid 302 of the covering portion 300 ensures insulation between the inner peripheral surface of the coil and the inner peripheral iron core 2a.

According to the three-phase reactor of the fifth embodiment, since the coil bobbin is a two-piece fitting assembly that is shared with part of the covering portion 300, the highly insulative covering portion can be easily manufactured.

The three-phase reactors according to the embodiments of this disclosure easily ensure insulation between the coil and the iron core, and between the individual coils.

What is claimed is:

1. A three-phase reactor comprising:
a coil having a winding portion;
an iron core partly disposed inside the winding portion; and
a covering portion containing the coil, and having an opening.

2. The three-phase reactor according to claim 1, further comprising:
an outer peripheral iron core; and
at least three core coils contacting, connected to, or magnetically connected to an inner surface of the outer peripheral iron core, wherein
each of the core coils includes the iron core and the coil wound around the iron core.

3. The three-phase reactor according to claim 1, further comprising an impregnant or a resin contained in the covering portion.

4. The three-phase reactor according to claim 1, wherein a slit is provided in at least part of the covering portion.

5. The three-phase reactor according to claim 1, wherein
the covering portion includes a covering portion main body and a lid, and
at least part of outer peripheries of the covering portion main body and the lid have shapes along an outer periphery of the coil.
